(19) United States
(12) Patent Application Publication
(10) Pub. No.: US 2010/0041775 A1
(43) Pub. Date: Feb. 18, 2010

(54) Inorganic nanoparticle dispersion liquid and method for producing the same, and composite composition

(75) Inventor: Koukichi Waki, Kanagawa (JP)

Correspondence Address: AKERMAN SENTERFITT, 8100 BOONE BOULEVARD, SUITE 700, VIENNA, VA, 22182-2683, US

(73) Assignee: FUJIFILM Corporation, Tokyo (JP)

(21) Appl. No.: 12/458,580

(22) Filed: Jul. 16, 2009

(30) Foreign Application Priority Data
Aug. 15, 2008 (JP) 2008-209220

(51) Int. Cl. B01F 3/12; B01F 17/00

(52) U.S. Cl. 516/88; 516/78

(57) ABSTRACT

A method for producing an inorganic nanoparticle dispersion liquid, including: substituting a first dispersion medium serving to disperse inorganic nanoparticles in an inorganic nanoparticle dispersion liquid by a second dispersion medium with a third dispersion medium intervening between the first dispersion medium and the second dispersion medium, wherein an absolute value of the difference in solubility parameter values (SP values) between the third dispersion medium and the second dispersion medium is smaller than 3.

### BACKGROUND OF THE INVENTION

1. Field of the Invention

The present invention relates to an inorganic nanoparticle dispersion liquid, in which a first dispersion medium serving to disperse inorganic nanoparticles in the inorganic nanoparticle dispersion liquid can be easily solvent substituted by a second dispersion medium, a method for producing an inorganic nanoparticle dispersion liquid, and a composite composition.

2. Description of the Related Art

An inorganic nanoparticle dispersion liquid is generally produced by using an easily dissolvable dispersion medium because of the demand for enhancing the solubility of a raw material compound to obtain a dispersion liquid having high concentration.

However, in order to form a film or composite by uniformly dissolving the thus produced inorganic nanoparticle dispersion liquid in a matrix agent such as polymers, the inorganic nanoparticles are necessary to be dissolved in the solvent in which the matrix agent is dispersed.

The solvent of the inorganic nanoparticle dispersion liquid prepared at first and the solvent in which the matrix agent is dissolved are less compatible in most cases, and the inorganic nanoparticles may aggregate or form gel upon solvent substitution.

For example, Japanese Patent Application Laid-Open (JP-A) No. 2005-298226 proposes a silica sol dispersed in an organic solvent, 5% by mass or more of which dissolves in water. JP-A No. 2005-298226 also discloses that an organic solvent having a solubility parameter (SP value) of 9 to 23.4 is preferably used as a dispersion medium used in the second dispersion liquid. However, it only discloses that the second dispersion medium preferably has a SP value of 9 to 23.4, but does not disclose compatibility between solvents at all. Moreover, it is limited to a water-soluble organic solvent having a solubility in water of 5% by mass or more.

JP-A No. 05-269365 proposes an inorganic oxide colloid modified with a silane coupling agent. JP-A No. 05-269365 discloses that it is preferred that the difference between the SP value of the dispersion medium and the SP value of the chain polymer compound, which is an atomic group of the silane coupling agent, be 1 to 5, because the silane coupling agent is selectively deposited on a particle surface with efficiency. However, JP-A No. 05-269365 merely discloses the SP value used as a value for suitably depositing the silane coupling agent, but does not disclose a solvent substitution at all.

Therefore, currently it is desired to provide a method for providing an inorganic nanoparticle dispersion liquid, in which solvent substitution can be easily and efficiently performed in such a manner that a first dispersion medium serving to disperse inorganic nanoparticles in the inorganic nanoparticle dispersion liquid is finally substituted by only a second dispersion medium without forming aggregations of the inorganic nanoparticles and gels of the dispersion liquid, and an inorganic nanoparticle dispersion liquid produced by using the method.

### BRIEF SUMMARY OF THE INVENTION

An object of the present invention is to provide a method for producing an inorganic nanoparticle dispersion liquid, in which solvent substitution can be easily and efficiently performed in such a manner that a first dispersion medium serving to disperse inorganic nanoparticles in the inorganic nanoparticle dispersion liquid is finally substituted by only a second dispersion medium without forming aggregations of the inorganic nanoparticles and gels of the dispersion liquid, a stable transparent inorganic nanoparticle dispersion liquid produced by using the method, and a composite composition.

Means for solving the above-mentioned problems are as follows.

<1> A method for producing an inorganic nanoparticle dispersion liquid, including substituting a first dispersion medium serving to disperse inorganic nanoparticles in an inorganic nanoparticle dispersion liquid by a second dispersion medium with a third dispersion medium intervening between the first dispersion medium and the second dispersion medium, wherein an absolute value of the difference in solubility parameter values (SP values) between the third dispersion medium and the second dispersion medium is smaller than 3.
<2> The method for producing an inorganic nanoparticle dispersion liquid according to <1>, wherein the second dispersion medium is a solvent for dispersing the inorganic nanoparticles in a matrix agent.
<3> The method for producing an inorganic nanoparticle dispersion liquid according to <1>, wherein the first dispersion medium is water, and the second dispersion medium is an organic solvent.
<4> The method for producing an inorganic nanoparticle dispersion liquid according to <1>, wherein the first dispersion medium is water containing 40% by volume or less of alcohol, and the second dispersion medium is an organic solvent.
<5> The method for producing an inorganic nanoparticle dispersion liquid according to <1>, wherein the first dispersion medium is alcohol having carbon atoms of 3 or less per molecule and containing 10% by volume or less of water, and the second dispersion medium is a hydrophobic organic solvent.
<6> The method for producing an inorganic nanoparticle dispersion liquid according to <1>, wherein the third dispersion medium is alcohol having carbon atoms of 2 or more.
<7> The method for producing an inorganic nanoparticle dispersion liquid according to <1>, wherein a plurality of third dispersion media are used, and the absolute value of the difference in the solubility parameter values (SP values) between one of the third dispersion media, which is used immediately before the second dispersion medium is added, and the second dispersion medium is smaller than 3.
<8> The method for producing an inorganic nanoparticle dispersion liquid according to <1>, wherein the inorganic nanoparticles are selected from the group consisting of a metal, an alloy, a metal oxide, and a complex metal oxide.
<9> An inorganic nanoparticle dispersion liquid obtained by a method for producing an inorganic nanoparticle dispersion liquid, which includes: substituting a first dispersion medium serving to disperse inorganic nanoparticles in the inorganic nanoparticle dispersion liquid by a second dispersion medium with a third dispersion medium intervening between the first dispersion medium and the second dispersion medium, wherein an absolute value of the difference in solubility parameter values (SP values) between the third dispersion medium and the second dispersion medium is smaller than 3.
<10> A composite composition including: an inorganic nanoparticle dispersion liquid; and a matrix agent, wherein the inorganic nanoparticle dispersion liquid is obtained by a method for producing an inorganic nanoparticle dispersion liquid, which includes: substituting a first dispersion medium serving to disperse inorganic nanoparticles in the inorganic nanoparticle dispersion liquid by a second dispersion medium with a third dispersion medium intervening between the first dispersion medium and the second dispersion medium, wherein an absolute value of the difference in solubility parameter values (SP values) between the third dispersion medium and the second dispersion medium is smaller than 3.

According to the present invention, the conventional problems can be solved, and a method in which a first dispersion medium serving to disperse inorganic nanoparticles in an inorganic nanoparticle dispersion liquid can be easily solvent substituted by a second dispersion medium without forming aggregations of the inorganic nanoparticles or gels of the dispersion liquid, a stable and highly transparent inorganic nanoparticle dispersion liquid produced by the method, and a composite composition can be provided.

### DETAILED DESCRIPTION OF THE INVENTION

### Inorganic Nanoparticle Dispersion Liquid and Method for Producing Inorganic Nanoparticle Dispersion Liquid

A method for producing an inorganic nanoparticle dispersion liquid of the present invention, including substituting a first dispersion medium serving to disperse inorganic nanoparticles in an inorganic nanoparticle dispersion liquid by a second dispersion medium with a third dispersion medium intervening between the first dispersion medium and the second dispersion medium, wherein an absolute value of the difference in solubility parameter values (SP values) between the third dispersion medium and the second dispersion medium is smaller than 3.

An inorganic nanoparticle dispersion liquid of the present invention is produced by the method for producing an inorganic nanoparticle dispersion liquid of the present invention.

Hereinafter, the inorganic nanoparticle dispersion liquid of the present invention will be specifically described through the description of the method for producing an inorganic nanoparticle dispersion liquid of the present invention.

The first dispersion medium serving to disperse the inorganic nanoparticles in the inorganic nanoparticle dispersion liquid means a dispersion medium used for preparing the inorganic nanoparticle dispersion liquid.

Examples of the first dispersion medium include water, water containing 40% by volume or less of alcohol, and alcohol having carbon atoms of 3 or less per molecule and containing 10% by volume or less of water.

The water is not particularly limited and may be appropriately selected depending on the purpose. Examples thereof include pure water, tap water, well water, spring water, fresh water, and these treated in various ways. Examples of the treatments to water include purification, heating, sterilization, filtration, and ion exchange. Thus, the water includes purified water and ion-exchanged water.

Examples of the alcohol contained in the water containing 40% by volume or less of alcohol include ethanol, isopropanol, 1-propanol, methanol, 1-butanol, and tert-butyl alcohol.

Examples of the alcohol having carbon atoms of 3 or less per molecule and containing 10% by volume or less of water include methanol and ethanol.

The second dispersion medium serving to disperse the inorganic nanoparticles in a matrix agent means a solvent in which the matrix agent serving to uniformly disperse the inorganic nanoparticles can be dissolved.

Examples of the organic solvent used as the second dispersion medium include various organic solvents such as hydrophilic organic solvents and hydrophobic organic solvents.

Examples of the hydrophilic organic solvents include N,N-dimethylacetamide, acetylacetone, acetone, aniline, allyl alcohol, ethanolamine, ethylene glycol, 1-octanol, glycerin, p-chlorotoluene, cyclohexanol, dimethyl sulfoxide, triethanolamine, and methyl ethyl ketone.

The hydrophobic organic solvents mean organic solvents having water solubility of 2 g/100 g or less, regardless of polarity or nonpolarity. Examples of the hydrophobic organic solvents include cyclohexane, hexane, heptane, n-octane, n-decane, butyl acetate, hexyl acetate, isooctane, 2-ethylhexanol, cyclohexane, toluene and n-hexanol.

Of these, particularly preferred are (1) an aspect that the first dispersion medium is the water and the second dispersion medium is the organic solvent, (2) an aspect that the first dispersion medium is the water containing alcohol of 40% by volume or less and the second dispersion medium is the organic solvent, and (3) an aspect that the first dispersion medium is the alcohol having carbon atoms of 3 or less per molecule and containing 10% by volume or less of water and the second dispersion medium is the hydrophobic organic solvent.

The third dispersion medium is not particularly limited as long as the absolute value of the difference in the solubility parameter values (SP values) between the third dispersion medium and the second dispersion medium is smaller than 3, and may be appropriately selected depending on the purpose. For example, alcohol having carbon atoms of 2 or more are preferred. Examples of the alcohol having carbon atoms of 2 or more include ethanol, 1-propanol, 1-butanol, 1-hexanol, isopropanol, tert-butyl alcohol. These may be used alone or in combination.

When a plurality of the third dispersion media are used, the absolute value of difference in the solubility parameter values (SP values) between one of the third dispersion medium, which is used immediately before the second dispersion medium is added, and the second dispersion medium is preferably smaller than 3. The absolute value of the difference in the solubility parameter values (SP values) between all third dispersion media and the second dispersion medium is preferably smaller than 3.

The absolute value of the difference in the solubility parameter values (SP values) between the second dispersion medium and the third dispersion medium is preferably smaller than 3, more preferably 2.5 or less, and still more preferably 0 to 2.0. When the absolute value of the difference in the solubility parameter values (SP values) is 3 or larger, aggregations and gelling easily occur, and it may be difficult to perform solvent substitution.

Here, the solubility parameter value (SP value) of the dispersion medium can be obtained by the following equation:

Solubility parameter value (SP value)=\sqrt{ΔH/V−RT}

where ΔH represents molar heat of vaporization of a dispersion medium, V represents a molar volume of the dispersion medium, R represents a gas constant and T represents an absolute temperature (° K.). The unit is (cal/cm³)^{1/2}.

ΔH can be referred to Kagaku Binran (Handbook of Chemistry), 5th Ed., basic II, edited by The Chemical Society Japan, (MARUZEN Co., Ltd. (2004)), if it cannot be referred thereto, it can be searched by internet (google), or an estimate is calculated by the following equation:

ΔH=−2950+23.7Tb+0.020Tb²

where Tb represents a boiling point of a dispersion medium (° K.).

V is found by dividing a density of a dispersion medium by a molecular mass of the dispersion medium (a molecular mass of the dispersion medium/a density of the dispersion medium). The molecular mass of the dispersion medium and the density of the dispersion medium can be referred to the unabridged dictionary of chemistry (KYORITSU SHUPPAN CO., LTD. (1964)).

The boiling point of the second dispersion medium is preferably higher than that of the first dispersion medium by 10° C. or more, more preferably 20° C. or more.

The boiling point of the second dispersion medium is preferably higher than that of the third dispersion medium to be intervened by 5° C. or more, more preferably 10° C. or more.

The inorganic nanoparticles used in the method for producing the inorganic nanoparticle dispersion of the present invention are not particularly limited and may be appropriately selected depending on the purpose. For example, the inorganic nanoparticles are preferably selected from the group consisting of metals, alloys, metal oxides, and complex metal oxides. Examples of the metals include single metals, alloys of two or more metals, which are composed of elements of fourth group to eleventh group of the periodic system.

Examples of the metal oxides include ZnO, GeO₂, TiO₂, ZrO₂, HfO₂, SiO₂, Sn₂O₃, Mn₂O₃, Ga₂O₃, Mo₂O₃, In₂O₃, Sb₂O₃, Ta₂O₅, V₂O₅, Y₂O₃, and Nb₂O₅.

Examples of the complex metal oxides include complex oxides of titanium and zirconium, complex oxides of titanium, zirconium and hafnium, complex oxides of titanium and barium, complex oxides of titanium and silicon, complex oxides of titanium, zirconium and silicon, complex oxides of titanium and tin, and complex oxides of titanium, zirconium and tin.

The method of producing the inorganic nanoparticles is not particularly limited and may be appropriately selected depending on the purpose. Examples of the methods classified by precipitation methods as a solution phase synthesis method of a single metal and alloy include (1) an alcohol reduction method using primary alcohol, (2) a polyol reduction method using secondary, tertiary, divalent or trivalent alcohol, (3) a thermal decomposition method, (4) an ultrasonic decomposition method, and (5) a reduction method using a strong reducing agent.

Moreover, examples of the methods classified by reaction system include (6) a polymer existence method, (7) a high-boiling point solvent method, (8) a normal micelle method, (9) a reverse-micelle method.

As for the metal oxides and complex metal oxides, a metal salt or a metal alkoxide as a raw material is hydrolyzed in a reaction system containing water so as to obtain desired inorganic nanoparticles. As a method of synthesizing the metal oxide, known methods as described in the Japanese Journal of Applied Physics, vol. 37, p. 4603-4608 (1998), or the Langmuir, vol. 16 (1), p. 241-246 (2000) may be used.

Examples of the metal salts include chlorides, bromides, iodides, nitrates, sulfates, and organic acid salts, of desired metals. Examples of the organic acid salts include acetates, propionates, naphthenates, octylates, stearates, and oleates. Examples of the metal alkoxides include methoxides, ethoxides, propoxides, and butoxides, of desired metals.

Particularly, when the metal oxide nanoparticles are synthesized by a sol formation method, it is possible to use a procedure in which a precursor such as a hydroxide is firstly formed, and then dehydrocondensed or deflocculated with an acid or an alkali, so as to form a hydrogel, as in the synthesis of titanium oxide nanoparticles using titanium tetrachloride as a raw material. In such a procedure of firstly forming a precursor, the precursor is preferably isolated and purified by an optional method such as filtration and centrifugal separation in terms of purity of a final product.

When the number average particle size of the inorganic nanoparticles used in the present invention is too small, properties inherent in the materials composing the nanoparticles may vary. On the other hand, when it is too large, influence of Rayleigh scattering may be remarkable, extremely decreasing transparency of the composite composition. Therefore, the number average particle size of the inorganic nanoparticles used in the present invention is preferably 1 nm to 20 nm, more preferably 1 nm to 10 nm, and particularly preferably 1 nm to 7 nm.

Here, the number average particle size is obtained by measuring a particle size of a transmission electron microscope (TEM) image, and statistically processing it.

The inorganic nanoparticles have a refractive index of preferably 1.9 to 3.0, more preferably 2.0 to 2.8, and still more preferably 2.2 to 2.7, at a wavelength of 589 nm and temperature of 22° C. When the refractive index is higher than 3.0, the difference in the refractive indices between the inorganic nanoparticles and the resin (the matrix agent) is so large that prevention of RayLeigh scattering may be difficult. When the refractive index is lower than 1.9, the effect of the refractive index may not be high enough for achieving the original purpose.

The refractive index of the nanoparticles can be estimated by a method in which the refractive index of a transparent film prepared by compounding the nanoparticles with a resin is measured by Abbe refractometer (e.g., DM-M4, produced by Atago Co., Ltd.), and then the obtained refractive index is compared with a refractive index of a resin component alone, which has been measured, or a method in which the refractive index of the nanoparticles is calculated by measuring the refractive indices of the dispersion liquids of the metal oxide nanoparticles having various concentrations.

By the method for producing an inorganic nanoparticle dispersion liquid of the present invention, a stable and highly transparent inorganic nanoparticle dispersion liquid can be efficiently produced without forming aggregations of the inorganic nanoparticles or gels of the dispersion liquid.

Moreover, according to the present invention, the inorganic nanoparticle dispersion liquid, which is produced by using an inexpensive raw material, can be subjected to solvent substitution using a relatively small amount of a solvent. Furthermore, a final dispersion liquid containing less aggregation can be obtained, so that a uniform and highly transparent film and composite can be produced. For example, the inorganic nanoparticle dispersion liquid of the present invention can be used for various molded products, organic/inorganic composite materials, coatings, inorganic pigment inks for printing, coating liquids for functional films, such as conductive films, electromagnetic shields, and the like. Of these, the inorganic nanoparticle dispersion liquid can be particularly preferably used in the composite composition of the present invention, which will be described below.

### (Composite Composition)

The composite composition of the present invention contains the inorganic nanoparticle dispersion liquid of the present invention and the matrix agent, and further contains an additive, a plasticizer, and if necessary, other components.

### <Matrix Agent>

The matrix agent is not particularly limited and may be appropriately selected depending on the purpose. For example, a thermoplastic resin is preferably used as the matrix agent.

The thermoplastic resin contains at least a structural unit expressed by General Formula (1). The thermoplastic resin is preferably a random copolymer having a carboxyl group in a side chain. The polymer can be selected from those conventionally known such as vinyl polymers which can be obtained by polymerization of vinyl monomer, polyether, polymers obtained by ring-opening metathesis polymerization, condensation polymers (for example, polycarbonate, polyester, polyamide, polyether ketone and polyether sulfone). Of these, vinyl polymers, polymers obtained by ring-opening metathesis polymerization, polycarbonate, and polyester are preferred, and vinyl polymers are more preferred in terms of production suitability.

—Structural unit expressed by General Formula (1)—

The thermoplastic resin used in the present invention contains at least a structural unit expressed by General Formula (1).

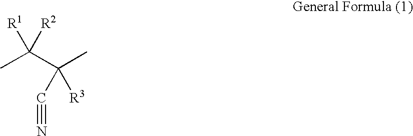

In General Formula (1), R¹ to R³ each independently represent a hydrogen atom, a halogen atom, a substituted or unsubstituted alkyl group, a substituted or unsubstituted alkoxy group, a substituted or unsubstituted alkylthio group, a substituted or unsubstituted acyloxy group, a substituted or unsubstituted aryl group, a substituted or unsubstituted aryloxy group, a substituted or unsubstituted arylthio group, a substituted or unsubstituted amino group, or a cyano group.

In the thermoplastic resin, one or a plurality of types of the structural unit(s) expressed by General Formula (1) may exist in one molecule. The structural units of expressed by General Formula (1) may be connected in a block form or may exist randomly, in a molecule

The structural unit expressed by General Formula (1) can be formed by polymerization of a monomer expressed by General Formula (2).

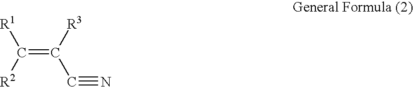

In General Formula (2), R¹ to R³ each independently represent a hydrogen atom, a halogen atom, a substituted or unsubstituted alkyl group, a substituted or unsubstituted alkoxy group, a substituted or unsubstituted alkylthio group, a substituted or unsubstituted acyloxy group, a substituted or unsubstituted aryl group, a substituted or unsubstituted aryloxy group, a substituted or unsubstituted arylthio group, a substituted or unsubstituted amino group, or a cyano group.

Hereinafter, specific examples of monomers expressed by General Formula (2) are expressed by A-1 to A-30. However, the monomers used in the present invention are not limited thereto.

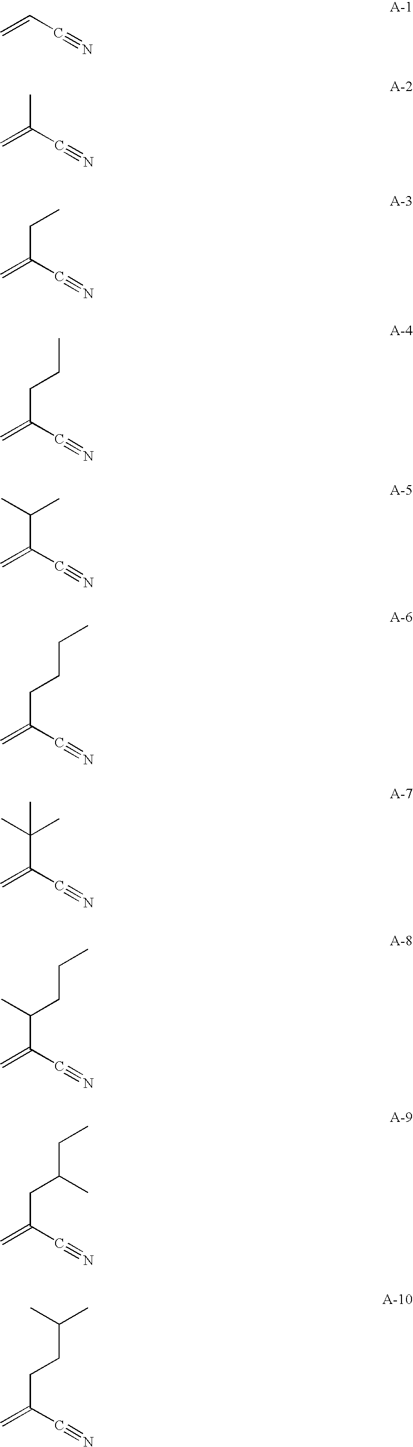

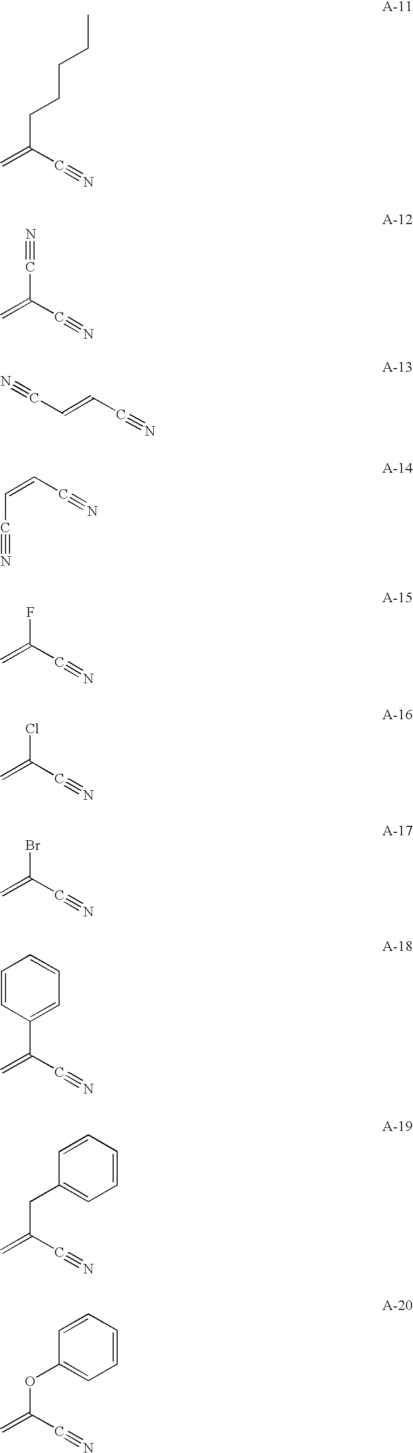

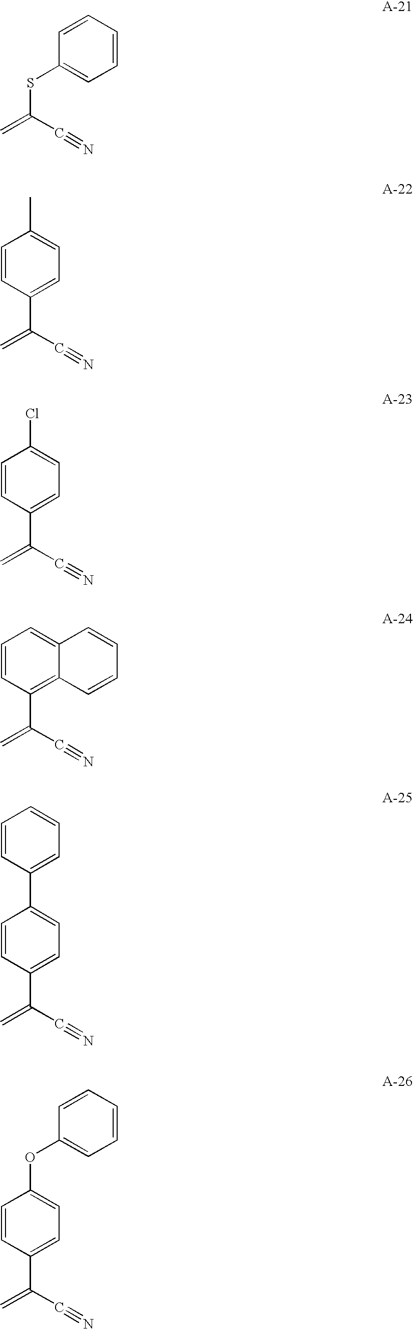

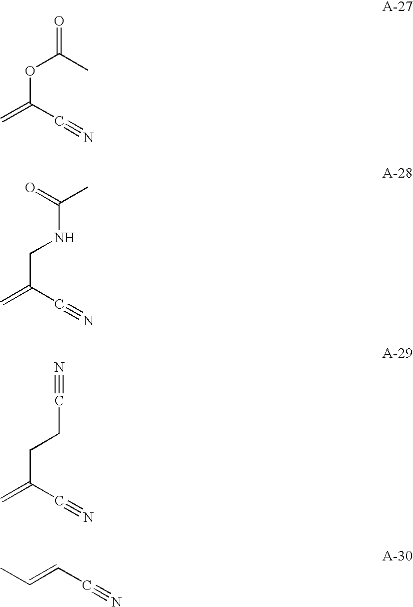

The thermoplastic resin contains the structural unit expressed by General Formula (1) preferably in an amount of 1% by mass to 70% by mass, more preferably 3% by mass to 70% by mass, still more preferably 5% by mass to 50% by mass, and particularly preferably 7% by mass 30% by mass. Here, the thermoplastic resin contains the structural unit expressed by General Formula (1) in an amount of 1% by mass to 70% by mass means a thermoplastic resin obtained by polymerization caused by containing a monomer which may form a structural unit expressed by General Formula (1) by polymerization (a monomer expressed by General Formula (2)) in an amount of 1% by mass to 70% by mass with respect to a total amount of the monomers in a monomer mixture.

### —Copolymerizable Monomer—

The thermoplastic resin used in the present invention can be produced by copolymerizing a monomer which can form the structural unit expressed by General Formula (1) by polymerization with other monomers. As the other monomers, those described in Polymer Handbook 2^{nd} ed., J. Brandrup, Wiley Interscience (1975), Chapter 2, pages 1 to 483, can be used.

Examples thereof include compounds having one addition polymerizable unsaturated bond, which are selected from styrene derivatives, 1-vinylnaphthalene, 2-vinylnaphthalene, vinylcarbazole, acrylic acid, methacrylic acid, acrylates, methacrylates, acrylamides, methacrylamides, allyl compounds, vinyl ethers, vinyl esters, dialkyl itaconates; and dialkylesters and monoalkylester of the fumaric acids.

The thermoplastic resin contains a structural unit derived from the copolymerizable monomer preferably in an amount of 30% by mass to 99% by mass, more preferably 30% by mass to 97% by mass, still more preferably 50% by mass to 95% by mass, and particularly preferably 70% by mass to 93% by mass. The thermoplastic resin preferably contains a structural unit derived from a vinyl monomer having an aromatic group preferably in an amount of 20% by mass to 99% by mass, more preferably 30% by mass to 97% by mass, and particularly preferably 40% by mass to 93% by mass.

As the copolymerizable monomer, a monomer having a functional group which can form a chemical bond with the inorganic nanoparticles is preferably used. As the functional group which can form a chemical bond with the inorganic nanoparticles, functional groups having one of the following structures will be exemplified.

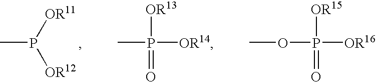

In the structures above, R¹¹, R¹², R¹³, R¹⁴, R¹⁵, and R¹⁶ each independently represent a hydrogen atom, a substituted or unsubstituted alkyl group, a substituted or unsubstituted alkenyl group, a substituted or unsubstituted alkynyl group, a substituted or unsubstituted aryl group, an atom or group which may form salts, —SO₃H or salts thereof, —OSO₃H or salts thereof, —CO₂H or salts thereof, —OH or salts thereof, —Si(OR¹⁷)ₙR¹⁸ₙ (where R¹⁷, R¹⁸ each independently represent a hydrogen atom, a substituted or unsubstituted alkyl group, a substituted or unsubstituted alkenyl group, a substituted or unsubstituted alkynyl group, a substituted or unsubstituted aryl group, or an atom or group which may form salts; and n represents an integer of 1 to 3).

A functional group which may form a chemical bond with the inorganic nanoparticles is introduced into a thermoplastic resin by polymerization reaction using a polymerizable monomer having the functional group or a precursor thereof, a method for introducing the functional group or a precursor thereof by reacting a resin with a reactant, or the like. From the standpoint of easiness of controlling the introduction of the functional group, a method of obtaining a resin by polymerization reaction using a polymerizable monomer having the functional group or a precursor thereof.

When a resin is obtained by polymerization reaction, a monomer which can polymerized with other monomers used in the present invention, such as diol compounds, dithiol compounds, dicarboxylic acid compounds can be used as a monomer having a functional group which can form a chemical bond with inorganic nanoparticles.

The thermoplastic resin preferably contains a structural unit derived from a vinyl monomer having the functional group preferably in an amount of 0.1% by mass to 5% by mass, more preferably 0.3% by mass to 3% by mass, and still more preferably 0.4% by mass to 2.5% by mass. Moreover, in the thermoplastic resin, the average number of the functional groups per one polymer chain is preferably 0.1 to 20, more preferably 0.5 to 10, and particularly preferably 1 to 5.

Examples of the monomers copolymerizable with the monomer which can form the structural unit expressed by General Formula (1) by polymerization include the monomers expressed below. However, monomers used in the present invention are not limited to these specific examples. In the monomers expressed below, n represents an integer of 1 or more.

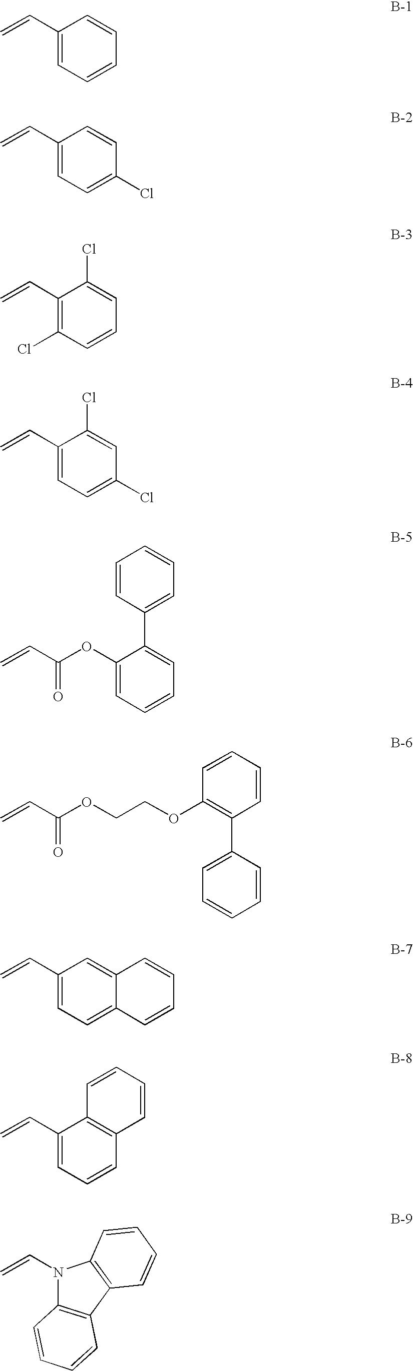

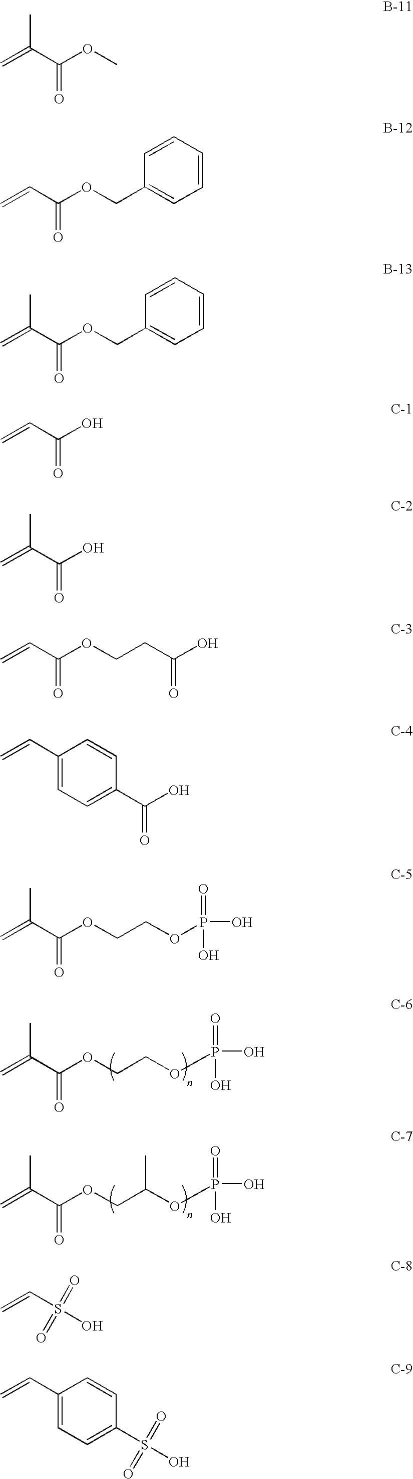

The number average molecular mass of the thermoplastic resin is preferably 10,000 to 200,000, more preferably 20,000 to 200,000, and still more preferably 50,000 to 200,000.

From the standpoint of heat resistance and molding property, the thermoplastic resin has a glass transition temperature (Tg) of preferably 80° C. to 400° C., more preferably 100° C. to 380° C., and still more preferably 100° C. to 300° C.

The refractive index of the thermoplastic resin is not particularly limited and may be appropriately selected depending on the purpose. When an organic/inorganic composite material is used in an optical component, which needs to have high refractive index, the thermoplastic resin preferably has high refractive index properties. In this case, the thermoplastic resin to be used has a refractive index, at a wavelength of 589 nm at 22° C., of preferably 1.55 or more, more preferably of 1.57 or more, and still more preferably 1.58 or more.

### —Additive—

In addition to the thermoplastic resin and inorganic nanoparticles, various additives may be appropriately incorporated therein, in order to improve uniform dispersibility, flowability, releasability and weather resistance in the molding process. Examples of the additives include surface treatment agents, plasticizers, antistatic agents, dispersants, and mold-releasing agents. Further, in addition to the thermoplastic resin, resins having no such functional group may be added. The types of these resins are not particularly limited, and it is preferred that resins having a thermal property, and molecular mass, similar to those of the thermoplastic resins.

A mixing ratio of the additives varies depending on the purpose. However, in general, the ratio is preferably 50% by mass or less, more preferably 30% by mass or less, and particularly preferably 20% by mass or less, with respect to the total amount of the inorganic nanoparticles and the thermoplastic resin.

### —Plasticizer—

When the thermoplastic resin of the present invention has a high glass transition temperature, the composite composition may not be always easily molded. In such a case, a plasticizer may be used to lower the molding temperature of the composite composition. An amount of the plasticizer based on the total amount of the composite composition is preferably 1% by mass to 50% by mass, more preferably 2% by mass to 30% by mass, and particularly preferably 3% by mass to 20% by mass.

The plasticizer used in the present invention needs to be selected with consideration of compatibility with a resin, weather resistance, plasticizing effect, and the like in total. An optimum plasticizer cannot be defined, because it depends on other components. But in terms of the refractive index, it is preferred to use those having an aromatic ring. As a typical example, a compound expressed by General Formula (3) is preferred.

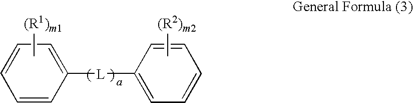

In the General Formula (3), R¹ and R² each independently represent a substitute; L represents an oxy group or methylene group; “a” represents 0 or 1; and m1 and m2 each independently represent an integer of 0 to 5.

Moreover, compounds expressed by any of General Formulas (4) to (6) are preferably used as the plasticizer.

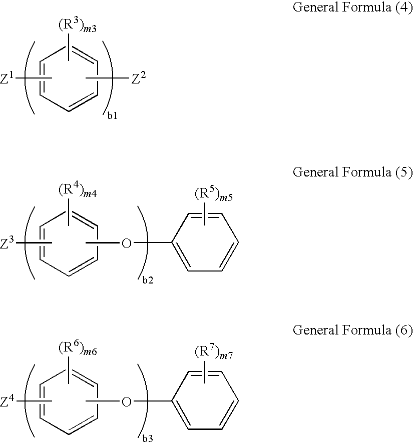

In General Formulas (4) to (6), R³, R⁴, R⁵, R⁶ and R⁷ each independently represent a substituent; Z¹, Z², Z³ and Z⁴ each independently represent a hydrogen atom or a substituent; m3, m4 and m6 each independently represent an integer of 0 to 4; m5 and m7 each independently represent an integer of 0 to 5; b1, b2 and b3 each independently represent an integer of 2 or more.

Furthermore, a compound expressed by General Formula (7) is also preferably used as the plasticizer.

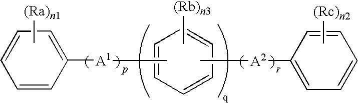

In General Formula (7), Ra, Rb and Rc each independently represent a substituent; A¹ represents an oxy group or methylene group. A² represents an oxy group, a substituted or unsubstituted alkylene group, a carbonyl group, a substituted or unsubstituted imino group, or combinations thereof; n1 and n2 each independently represent an integer of 0 to 5; n3 represents an integer of 0 to 4; p, q, and r each independently represent an integer of 0 or 1; provided that when q is 0, r is 0.

### <Molded Product>

A molded product can be produced by molding the composite composition of the present invention.

When the composite composition is prepared by mixing the inorganic nanoparticle dispersion liquid of the present invention and a thermoplastic resin solution, a transparent molded product can be obtained by directly cast molding the mixed solution. The method enables to produce a molded product outstandingly easily and quickly at low cost. The obtained molded product has extremely high transparency. When a molded product is produced by using a conventional composite composition, white turbidity may be possibly formed. Thus, drying speed is slowed and it takes long time for the molded product to dry in most cases. On the other hand, when a molded product is produced by using the composite composition of the present invention, the molded product can be dried quickly because white turbidity is not formed. By using the composite composition of the present invention, a transparent molded product can be obtained by drying with taking less time, so as to improve the production efficiency and to keep production cost low.

The molded product can be produced by methods other than the cast molding. For example, the molded product can be produced by a method, in which a solvent is removed from the composite composition of the present invention by a technique such as condense, or freeze-drying of a solution, or reprecipitation from an appropriate poor solvent, and then a solid content of powder is molded by a conventionally known technique such as injection molding, compression molding, or the like. In this case, the powder composite composition can be directly processed to a molded product such as a lens by heating and melting, or compressing. Alternatively, the powder composite composition can be processed to an optical component such as a lens in such a manner that a preform (precursor) having a certain weight and shape is prepared by an extrusion process, and then the preform is transformed by compression molding. In this case, the perform may have an appropriate curvature in order to efficiently form the desired shape.

Moreover, the composite composition may be mixed in other resins as a master batch.

Of the molded products, those having the refractive index as described in regard to the composite composition are useful.

The molded product is particularly advantageously used for optical components having a thickness of 0.1 mm or more and having a high refractive index, more preferably for those having a thickness of 0.1 mm to 5 mm, particularly preferably for transparent components having a thickness of 1 mm to 3 mm.

The optical component using the molded product is not particularly limited as long as the optical component utilizes the excellent optical performance of the composite composition of the present invention, and may be appropriately selected depending on the purpose. For example, the molded product can be used as lens base materials, or light transmissive optical components (so-called, passive optical components). Examples of optical functional devices equipped with such optical components include various display devices (e.g., liquid crystal displays and plasma displays), various projector devices (e.g., OHPs and liquid crystal projectors), optical fiber communication devices (e.g., optical waveguides and optical amplifiers), and photographic devices such as cameras and videos. Examples of the passive optical components used in the optical functional devices include lenses, prisms, prism sheets, panels, films, optical waveguides, optical discs, and sealants of LED.

### EXAMPLES

Hereinafter, the present invention will be explained by way of Examples, which should not be construed as limiting the present invention.

### Example 1

### Production of Inorganic Nanoparticle Dispersion Liquid (a)

Under acidic conditions of pH 0.5, a water dispersion liquid containing 5% by mass of TiO₂ nanoparticles including 10 mol % of SnO₂ and 17 mol % of ZrO₂ was prepared. The dispersion liquid contains approximately 5% by volume of ethanol and approximately 7% by volume of isopropanol. Moreover, a by-product salt and residual raw material in the dispersion liquid were removed by electrodialysis so that the electric conductivity became 100 μS/cm or less.

Next, water which was a main dispersion medium of the dispersion liquid (first dispersion medium) was substituted with an organic solvent by the following solvent substitution method.

N,N-dimethylacetamide as a second dispersion medium, p-propyl benzoate as a dispersant, and 1-propanol as a third dispersion medium to be intervened were selected.

In 300 mL of 1-propanol, 1 g of p-propyl benzoate was dissolved, and 100 mL of the obtained dispersion liquid was slowly added therein while stirring. The mixed liquid was subjected to distillation under reduced pressure (first) at 55° C. and 80 hPa to 100 hPa until the liquid amount became 100 mL. Next, in the mixed liquid 100 mL of 1-propanol was further added while stirring, and then the mixed liquid was subjected to distillation under reduced pressure (second) at 55° C. and 80 hPa to 100 hPa until the liquid amount became 100 mL. Moreover, in the mixed liquid 100 mL of N,N-dimethylacetamide was further added while stirring, and then the mixed liquid was still further subjected to distillation under reduced pressure (third) at 55° C. and 50 hPa to 80 hPa, and followed by at 60° C. and 50 hPa until the liquid amount became 100 mL.

In this way, a stable transparent TiO₂ nanoparticle dispersion liquid (a) containing only N,N-dimethylacetamide as a dispersion medium was obtained.

### Example 2

### Production of Inorganic Nanoparticle Dispersion Liquid (b)

A stable transparent TiO₂ nanoparticle dispersion liquid (b) containing only butyl acetate as a dispersion medium was obtained in the same manner as in Example 1, except that the second dispersion medium was replaced with butyl acetate, that as the third dispersion medium 1-propanol was used in the first distillation under reduced pressure, and 1-butanol was used instead of 1-propanol in the second distillation under reduced pressure, and that the third distillation under reduced pressure was performed at 55° C. and 50 hPa to 80 hPa.

### Example 3

### Production of Inorganic Nanoparticle Dispersion Liquid (c)

At room temperature an aqueous sodium hydroxide solution was added in an aqueous zinc acetate solution while stirring, and then heated and aged to obtain a water dispersion liquid containing 5% by mass of ZnO nanoparticles. In the water dispersion liquid, acetic acid was added as a dispersant, and a by-product salt and residual raw material therein were removed by electrodialysis so that the electric conductivity became 100 μS/cm or less.

Next, water as a dispersion medium of the dispersion liquid (a first dispersion medium) was substituted with an organic solvent by the following solvent substitution method.

Cyclohexanol as a second dispersion medium, acetic acid as a dispersant, and 1-propanol as a third dispersion medium to be intervened were selected.

In 300 mL of 1-propanol, 0.5 mL of acetic acid was dissolved, and 100 mL of the obtained dispersion liquid was slowly added therein while stirring. The mixed liquid was subjected to distillation under reduced pressure (first) at 55° C. and 80 hPa to 100 hPa until the liquid amount became approximately 100 mL. Next, in the mixed liquid 100 mL of 1-propanol was further added, and then the mixed liquid was further subjected to distillation under reduced pressure (second) at 55° C. and 80 hPa to 100 hPa until the liquid amount became 100 mL. Moreover, in the mixed liquid 100 mL of N,N-dimethylacetamide was further added, and then the mixed liquid was still further subjected to distillation under reduced pressure (third) followed by at 55° C. and 50 hPa to 80 hPa, and at 60° C. and 50 hPa until the liquid amount became 100 mL.

In this way, a stable transparent ZnO nanoparticle dispersion liquid (c) containing only cyclohexanol as a dispersion medium was obtained.

### Example 4

### Production of Inorganic Nanoparticle Dispersion Liquid (d)

A Pt nanoparticle dispersion liquid was produced by a reverse-micelle method as follows.

An alkane solution obtained by dissolving 100 g of AEROSOL OT (manufactured by TOKYO CHEMICAL INDUSTRY CO., LTD.) in 800 mL of decane (manufactured by Wako Pure Chemical Industries, Ltd.) was added and mixed in an aqueous metal salt solution obtained by dissolving 5.32 g of potassium chloroplatinate (K₂PtCl₄) (manufactured by Wako Pure Chemical Industries, Ltd.) in 240 mL of H₂O so as to prepare a reverse micellar solution (A).

Next, an alkane solution obtained by dissolving 100 g of AEROSOL OT (manufactured by TOKYO CHEMICAL INDUSTRY CO., LTD.) in 800 mL of decane (manufactured by Wako Pure Chemical Industries, Ltd.) was added and mixed in an aqueous reducing agent solution obtained by dissolving 2.42 g of NaBH₄ (manufactured by Wako Pure Chemical Industries, Ltd.) in 240 mL of H₂O so as to prepare a reverse micellar solution (B).

While the reverse micellar solution (B) was stirred at high speed, the reverse micellar solution (A) was added quickly in the reverse micellar solution (B), and then 10 minutes later, 1 mL of mercaptoethanol (manufactured by Wako Pure Chemical Industries, Ltd.) was added therein, and then aged at 40° C. for 2 hours.

After the aged solution was cooled, a mixed solvent of water/ethanol (1:1) was added therein, and subjected to phase separation so as to take out an aqueous phase containing nanoparticles, and a by-product salt and residual raw material were removed by ultrafiltration with further adding ethanol. Then, a dispersion liquid containing 5% by mass of Pt nanoparticles dispersed in an ethanol dispersion medium containing approximately 8% by volume of water was prepared so as to have a total liquid amount of 50 mL and a final electric conductivity of 100 μS/cm or less.

Next, an ethanol dispersion medium containing approximately 8% by volume of water which is a dispersion medium of the dispersion liquid (a first dispersion medium) was substituted with a hydrophobic organic solvent by the following solvent substitution method.

Cyclohexane as a second dispersion medium, 1-octanethiol as a dispersant, and 1-butanol and 1-hexanol as third dispersion media to be intervened were selected.

In 300 mL of 1-butanol, 0.5 mL of 1-octanethiol was dissolved, and 50 mL of the dispersion liquid was slowly added therein while stirring. The mixed liquid was subjected to distillation under reduced pressure (first) at 60° C. and 60 hPa to 80 hPa until the liquid amount became approximately 50 mL. Next, in the mixed liquid 100 mL of 1-hexanol was further added while stirring, and then the mixed liquid was further subjected to distillation under reduced pressure (second) at 60° C. and 40 hPa to 80 hPa until the liquid amount became 50 mL. Moreover, in the mixed liquid 50 mL of cyclohexane was further added while stirring, and then the mixed liquid was still further subjected to distillation under reduced pressure (third) at 60° C. and 20 hPa to 60 hPa until the liquid amount became 50 mL.

In this way, a stable transparent Pt nanoparticle dispersion liquid (d) containing only cyclohexanol as a dispersion medium was obtained.

### Example 5

### Production of Inorganic Nanoparticle Dispersion Liquid (e)

A stable nanoparticle dispersion liquid (e) (50 mL) containing 5% by mass of AgPd (approximately 20 mol % of Pd) having high transmission was obtained in the same manner as in Example 4, except that the potassium chloroplatinate (K₂PtCl₄) (manufactured by Wako Pure Chemical Industries, Ltd.) was replaced with 4.18 g of silver perchlorate (AgClO₄.H₂O) (manufactured by Wako Pure Chemical Industries, Ltd.) and 1.31 g of palladium chloride (PdCl₂) (manufactured by Wako Pure Chemical Industries, Ltd.).

### Example 6

### Production of Inorganic Nanoparticle Dispersion Liquid (f)

A transparent stable TiO₂ nanoparticle dispersion liquid (f) containing only N,N-dimethylacetamide as a dispersion medium was obtained in the same manner as in Example 1, except that the third dispersion medium to be intervened in Example 1 was replaced with ethanol.

### Comparative Example 1

### Production of Inorganic Nanoparticle Dispersion Liquid (g)

An inorganic nanoparticle dispersion liquid of Comparative Example 1 was obtained in the same manner as in Example 1, except that the mixed liquid was subjected to distillation under reduced pressure and solvent substitution without using the third dispersion medium to be intervened. During the process, although gelling and aggregations of the nanoparticles occurred, the process was continued, thereby obtaining a TiO₂ nanoparticle dispersion liquid containing only N,N-dimethylacetamide as a dispersion medium. The dispersion liquid was an inorganic nanoparticle dispersion liquid (g) having gel in part and a little white turbidity.

### Comparative Example 2

### Production of Inorganic Nanoparticle Dispersion Liquid (h)

An inorganic nanoparticle dispersion liquid of Comparative Example 2 was obtained in the same manner as in Example 2, except that the third dispersion medium to be intervened of Example 2 was replaced with ethanol (manufactured by Wako Pure Chemical Industries, Ltd.). During the process, although gelling and aggregations of the nanoparticles occurred, the process was continued, thereby obtaining a TiO₂ nanoparticle dispersion liquid containing only butyl acetate as a dispersion medium. The dispersion liquid was an inorganic nanoparticle dispersion liquid (h) containing gel in part and white turbidity.

### Comparative Example 3

### Production of Inorganic Nanoparticle Dispersion Liquid (i)

An inorganic nanoparticle dispersion liquid of Comparative Example 3 was obtained in the same manner as in Example 4, except that the third dispersion medium to be intervened of Example 4 was replaced with methanol (manufactured by Wako Pure Chemical Industries, Ltd.). During the process, the phase separation and gelling occurred, and the first dispersion medium was hardly substituted by the second dispersion medium. In this way, an inorganic nanoparticle dispersion liquid (i) was obtained.

The solubility parameter values (SP values) of second dispersion media, types of third dispersion media, solubility parameter values (SP values) of third dispersion media, which were used in Examples 1 to 6 and Comparative Examples 1 to 3, and transmission of the inorganic nanoparticle dispersion liquids (a) to (i) were obtained as follows. The results are shown in Table 1.

### <Method for Obtaining Solubility Parameter>

Here, the solubility parameter value (SP value) of the dispersion medium was obtained by the following equation.

Solubility parameter value (SP value)=\sqrt{ΔH/V−RT}

where ΔH represents molar heat of vaporization of a dispersion medium, V represents a molar volume of the dispersion medium, R represents a gas constant and T represents an absolute temperature (° K.). The unit is (cal/cm³)^{1/2}.

ΔH was referred to Kagaku Binran (Handbook of Chemistry), 5th Ed., basic II, edited by The chemical Society Japan, (MARUZEN Co., Ltd. (2004)), if it could not be referred thereto, it was searched by internet (google), or an estimate was calculated by the following equation:

ΔH=−2950+23.7Tb+0.020Tb²

where Tb represents a boiling point of a dispersion medium (° K.).

V was obtained by dividing a density of a dispersion medium by a molecular mass of the dispersion medium (a molecular mass of the dispersion medium/a density of the dispersion medium). The molecular mass of the dispersion medium and the density of the dispersion medium were referred to the unabridged dictionary of chemistry (KYORITSU SHUPPAN CO., LTD. (1964)).

### <Transmittance of Inorganic Nanoparticle Dispersion Liquid>

The transmittance of the inorganic nanoparticle dispersion liquid was obtained by measuring with a spectrophotometer (U-3310) (manufactured by Hitachi High-Technologies Corporation).

TABLE 1

| | | | | Third dispersion medium | | Absolute values | |
|---|---|---|---|---|---|---|---|
| | | | Solubility parameter | used immediately before | Solubility parameter | of the difference | Transmittance |
| | | Second dispersion | value of second | the second dispersion | value of third | in the solubility | (%) |
| | | medium | dispersion medium | medium was added | dispersion medium | parameter values | (λ = 800 nm) |
| (a) | Ex. 1 | N,N-dimethylacetamide | 10.8 | 1-propanol | 11.1 | 0.3 | 99.5 |
| (b) | Ex. 2 | butyl acetate | 8.7 | 1-butanol | 10.5 | 1.8 | 96.5 |
| (c) | Ex. 3 | cyclohexanol | 9.8 | 1-propanol | 11.1 | 1.3 | 98.0 |
| (d) | Ex. 4 | cyclohexanone | 8.2 | 1-hexanol | 9.6 | 1.4 | 88.0 |
| (e) | Ex. 5 | cyclohexanone | 8.2 | 1-hexanol | 9.6 | 1.4 | 85.3 |
| (f) | Ex. 6 | N,N-dimethylacetamide | 10.8 | ethanol | 12.2 | 1.4 | 94.9 |
| (g) | Comp. Ex. 1 | N,N-dimethylacetamide | 10.8 | N/A | — | — | 30.5 |
| (h) | Comp. Ex. 2 | butyl acetate | 8.7 | ethanol | 12.2 | 3.5 | 22.0 |
| (i) | Comp. Ex. 3 | cyclohexanone | 8.2 | methanol | 13.9 | 5.7 | — |

As can be seen from the results of Table 1, it was fount that the inorganic nanoparticle dispersion liquid produced by the method for producing an inorganic nanoparticle dispersion liquid of the present invention was transparent and stable, and had high transmittance.

### Example 7

By the use of the inorganic nanoparticle dispersion liquids produced in Examples 1, 2 and 6, composite compositions were produced by the following method, and then molded products were produced.

A resin of copolymer (refractive index: 1.59) (5 g) containing 78.5% poly(p-chlorostyrene), 20% polyacrylonitrile and 1.5% polyacryl acetate was dissolved in 50 mL of N,N-dimethylacetamide so as to prepare a solution. In each of the solutions, 80 mL (equivalent to 4 g of particles) of the TiO₂ nanoparticle dispersion liquid (a) of Example 1 and the TiO₂ nanoparticle dispersion liquid (f) of Example 6 were added, and were stirred and mixed to obtain transparent uniform composite compositions (1) and (2).

In 50 mL of butyl acetate, 5 g of the copolymer resin was dissolved and 80 mL (equivalent to 4 g of particles) of the TiO₂ nanoparticle dispersion liquid (b) of Example 2 was added therein, and were stirred and mixed to obtain a transparent uniform composite composition (3).

Next, these composite compositions (1), (2) and (3) were dried and pulverized, and then 0.25 g of the composite compositions (1), (2) and (3) were respectively pressed at 180° C. to produce molded products having a diameter of 8 mm and a thickness of 1 mm. All of the obtained molded products were transparent and colorless and had a high refractive index of 1.67.

The inorganic nanoparticle dispersion liquid, and composite composition produced by the method for producing an inorganic nanoparticle dispersion liquid of the present invention is stable and highly transparent, and can be used for various molded products, organic/inorganic composite materials, coatings, inorganic pigment inks for printing, coating liquids for functional films, such as conductive films, electromagnetic shields, and the like.

What is claimed is:

1. A method for producing an inorganic nanoparticle dispersion liquid, comprising:
substituting a first dispersion medium serving to disperse inorganic nanoparticles in an inorganic nanoparticle dispersion liquid by a second dispersion medium with a third dispersion medium intervening between the first dispersion medium and the second dispersion medium,
wherein an absolute value of the difference in solubility parameter values (SP values) between the third dispersion medium and the second dispersion medium is smaller than 3.

2. The method for producing an inorganic nanoparticle dispersion liquid according to claim 1, wherein the second dispersion medium is a solvent for dispersing the inorganic nanoparticles in a matrix agent.

3. The method for producing an inorganic nanoparticle dispersion liquid according to claim 1, wherein the first dispersion medium is water, and the second dispersion medium is an organic solvent.

4. The method for producing an inorganic nanoparticle dispersion liquid according to claim 1, wherein the first dispersion medium is water containing 40% by volume or less of alcohol, and the second dispersion medium is an organic solvent.

5. The method for producing an inorganic nanoparticle dispersion liquid according to claim 1, wherein the first dispersion medium is alcohol having carbon atoms of 3 or less per molecule and containing 10% by volume or less of water, and the second dispersion medium is a hydrophobic organic solvent.

6. The method for producing an inorganic nanoparticle dispersion liquid according to claim 1, wherein the third dispersion medium is alcohol having carbon atoms of 2 or more.

7. The method for producing an inorganic nanoparticle dispersion liquid according to claim 1, wherein a plurality of third dispersion media are used, and the absolute value of the difference in the solubility parameter values (SP values) between one of the third dispersion media, which is used immediately before the second dispersion medium is added, and the second dispersion medium is smaller than 3.

8. The method for producing an inorganic nanoparticle dispersion liquid according to claim 1, wherein the inorganic nanoparticles are selected from the group consisting of a metal, an alloy, a metal oxide, and a complex metal oxide.

9. An inorganic nanoparticle dispersion liquid obtained by a method for producing an inorganic nanoparticle dispersion liquid, which comprises:
substituting a first dispersion medium serving to disperse inorganic nanoparticles in the inorganic nanoparticle dispersion liquid by a second dispersion medium with a third dispersion medium intervening between the first dispersion medium and the second dispersion medium,
wherein an absolute value of the difference in solubility parameter values (SP values) between the third dispersion medium and the second dispersion medium is smaller than 3.

10. A composite composition comprising:
an inorganic nanoparticle dispersion liquid; and
a matrix agent,
wherein the inorganic nanoparticle dispersion liquid is obtained by a method for producing an inorganic nanoparticle dispersion liquid, which comprises:
substituting a first dispersion medium serving to disperse inorganic nanoparticles in the inorganic nanoparticle dispersion liquid by a second dispersion medium with a third dispersion medium intervening between the first dispersion medium and the second dispersion medium,
wherein an absolute value of the difference in solubility parameter values (SP values) between the third dispersion medium and the second dispersion medium is smaller than 3.
